(19) United States
(12) Patent Application Publication
(10) Pub. No.: US 2003/0183123 A1
(43) Pub. Date: Oct. 2, 2003

(54) Organic compounds

(76) Inventor: Roland Wald, Huningue (FR)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/344,055

(22) PCT Filed: Aug. 8, 2001
(86) PCT No.: PCT/IB01/01411

(30) Foreign Application Priority Data
Aug. 9, 2000 (GB) 0019464.7

(51) Int. Cl. C09D 11/00; C09B 29/00; C09B 62/085

(52) U.S. Cl. 106/31.48; 8/684; 534/635; 534/767

(57) ABSTRACT

According to the invention there are provided fiber-reactive dyestuffs which are compounds of the formula (I)

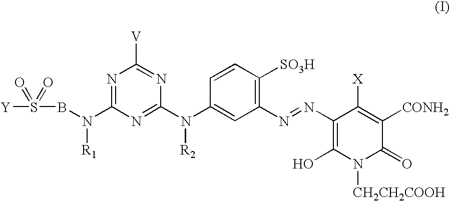

wherein the substituents are defined as in claim 1,

a process making the same and their use in dyeing or printing hydroxy-group-containing organic substrates.

This invention relates to fiber-reactive dyestuffs, a process of making the same and to their use in dyeing or printing hydroxy-group-;containing or nitrogen-containing organic substrates.

According to the invention there are provided fiber-reactive dyestuffs which are compounds of the formula (I)

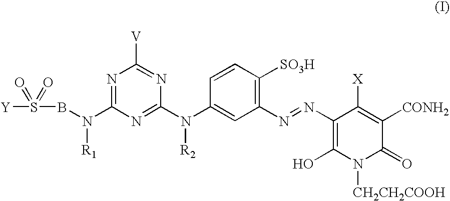

wherein

B is a divalent group,

R₁ and R₂ are independently from each other H or an optionally substituted

C₁₋₆alkyl-group,

V is Cl or F,

X signifies a —C₁₋₆-alkyl group,

Y signifies a —CH═CH₂ group or a —CH₂CH₂-Z group, wherein Z is a radical which can be eliminated by alkali,

or a salt thereof and/or mixtures thereof.

The alkyl groups can be linear or branched.

Preferably B is an aliphatic, an aromatic or an araliphatic group. This group can be linear, branched or cyclic. The group can optionally be substituted by one or more substituents and/or interrupted by one or more heteroatoms chosen from the group O, S and N.

Preferably the substituents are chosen from the group consisting of C₁₋₄-alkyl, —OH, —SO₃H, —COOH or —CN.

For the case that B is an aliphatic group, the number of C-atoms goes from 1 to 10, preferably from 1 to 6.

For the case that B is an aromatic group, the number of C-atoms goes from 4 to 20. Preferably the B comprises an optionally substituted benzene and/or an optionally substituted naphthalene group.

Preferably X is a C₁₋₄alkyl group, more preferably a —CH₃ group.

Preferably Z is a —OSO₃H group.

Preferably R₁ is H or an unsubstituted C₁₋₆-alkyl group, more preferably H or an unsubstituted C₁₋₄-alkyl-group, most preferably a H or a —C₂H₅ group.

Preferably R₂ is H or an unsubstituted C₁₋₆-alkyl group, more preferably H or an unsubstituted C₁₋₄-alkyl-group, most preferably a H.

When a fiber-reactive dyestuff of formula (I) is in its salt-form, the cation associated with the sulpho-groups is not critical and may be any of those non-chromophoric cations conventional in the field of fiber-reactive dyestuffs provided that the corresponding salt is substantially water soluble. Examples of such cations are alkali metal cations, for example potassium, lithium or sodium ions and ammonium cations, e.g. mono-, di-, tri- and tetra-methyl or mono-, di-, tri- and tetra-ethyl ammonium cations. The cations may be the same or different, i.e. the compounds may be in mixed salt-form.

A fiber-reactive dyestuff of formula (I) displays good compatibility with other known dyestuffs. Accordingly, it may be mixed with other dyestuffs to form a composition, which can be used to dye or print suitable substrates. Said other dyestuffs must be compatible with a compound of formula (I), that is, they must have similar dyeing or printing properties, for example fastness properties.

Accordingly, the invention provides in another of its aspects a dyeing or printing composition comprising a fiber-reactive dyestuff of the formula (I).

In another aspect of the invention there is provided a process of forming a fiber-reactive dyestuff of formula (I) or a salt thereof comprising the step of reacting a diazotized compound of the formula (II)

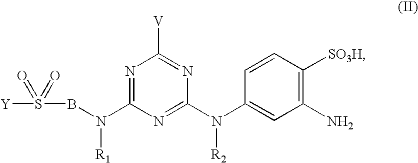

wherein all substituents have the meanings as defined above,

with a compound of the formula (Ill)

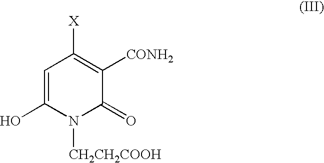

wherein X has the meaning as defined above.

The process is preferably carried out in an aqueous medium at a temperature of from 0 to 25° C., more preferably 0 to 10° C. and at a pH of between 1 to 7, more preferably 1 to 6.

A fiber-reactive dyestuff of formula (I) may be isolated in accordance with known methods, for example by salting out, filtering and drying optionally in vacuum and at slightly elevated temperature.

Depending on the reaction and/or isolation conditions, a fiber-reactive dyestuff of the formula (I) may be obtained in free-acid or salt-form or mixed salt-form, containing for example one or more of the above-mentioned cations. A fiber-reactive dyestuff of formula (I) may be converted from salt-form or mixed salt-form to free-acid form or vice versa using conventional techniques.

The compounds (II) are obtainable by a condensation reaction of

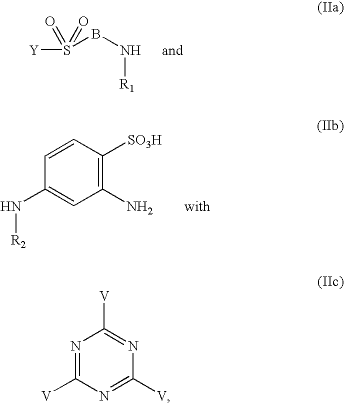

wherein all substituents have the meanings as defined above.

The compounds (III) are derivable by well known syntheses from commonplace starting materials well known to persons skilled in the art.

A fiber-reactive dyestuff of the formula (I) is useful as a fiber-reactive dyestuff for dyeing or printing hydroxy-group-containing or nitrogen-containing organic substrates. Preferred substrates are leather and fibrous materials which comprise natural or synthetic polyamides and, particularly, natural or regenerated cellulose such as cotton, viscose and spun rayon. The most preferred substrates are textile materials comprising cotton.

Accordingly, in another aspect of the invention there is provided the use of a fiber-reactive dyestuff according to the formula (I) or a salt thereof as a fiber-reactive dyestuff for dyeing or printing hydroxy-group-containing or nitrogen-containing organic substrates.

Dyeing or printing may be carried out in accordance with known methods conventional in the fiber-reactive dyestuff field.

In a preferred dyeing process the exhaust-dyeing method is used at temperatures within the range of from 40 to 100° C., more preferably 50 to 80° C. A fiber-reactive dyestuff of formula (I) gives good exhaust and fixation yields. Moreover, any unfixed dyestuff is easily washed from the substrate.

In a preferred printing process, the padding method is used, for example pad-steam, pad-thermofix, pad-dry, pad-batch, pad-jig and pad-roll. Alternatively, printing may be carried out using ink-jet methods.

A dyeing or print obtained with said fiber-reactive dyestuff exhibits good wet and light fastness. They also exhibit good resistance to oxidizing agents such as chlorinated water, hypochlorites, peroxides and perborate-containing washing detergents. Furthermore, a dyeing or print obtained with said fiber-reactive dyestuff of formula (I) display high stability to acid hydrolysis, for example a dyeing when contacted with dilute acetic acid only causes a slight staining of an undyed accompanying fabric.

Dyeings and prints obtained using mixtures of dyestuffs display good fastness properties which are comparable with those fastness properties obtained with a compound of formula (I) alone.

There now follows a series of examples, which serve to illustrate the invention.

### EXAMPLE 1

62 parts of 3-ethylamino-benzene(2′-sulfatoethylsulfone) are dissolved in 250 parts of water the pH is adjusted with 15% sodium carbonate solution at 4 and the resulting mixture is cooled down to 8-12° C. At this temperature a stirred suspension of 37 parts of 2,4,6-trichlorotriazine in 160 parts of ice/water is added during 5 minutes. The reaction mixture is stirred for some 200 minutes more. The pH is increased to 4.5-5 by addition of 15% sodium carbonate solution. Once the reaction is accomplished a solution made by dissolving 37 parts of 2,4-diaminobenzenesulfonic acid with 26 parts of sodium hydroxide (30%) in 200 parts of water is added to the reaction mixture. Then the pH is increased to 5.5-6 by addition of 15% sodium carbonate solution and the temperature is maintained at 15-20° C.

The reaction mixture is cooled down to 0-5° C. and is diazotized by addition of 90 parts of hydrochloric acid (30%) and 13.6 parts sodium nitrite.

After the diazotation is finished and diazo mixture is added to the solution made by dissolving 47 parts of a compound according to the formula (IV)

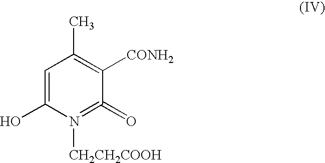

with 50 parts of sodium hydroxide (30%) in 200 parts of water. The pH value is raised further to 1 to 6 by addition of 15% sodium carbonate solution and the obtained solution spray dried. About 250 parts of a yellow salt containing powder are obtained which dyes cellulose fibers in yellow shades. The dyestuff corresponds to the formula (V)

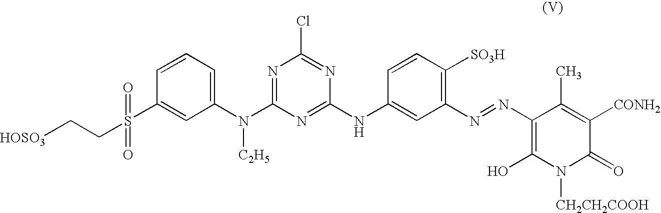

and the resultant dyeings exhibited excellent light and wet fastness properties whereby the unfixed dyestuff can easily be washed out, even from deep dyeings, and were resistant to oxidative influences.

TABLE 1
Examples 2-24

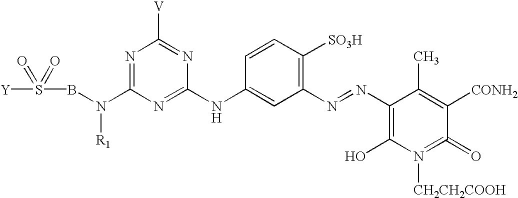

| Example | R₁ | —B—* | V | Y |
|---|---|---|---|---|
| 2 | C₂H₅ | 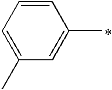 | Cl | —CH═CH₂ |
| 3 | C₂H₅ | 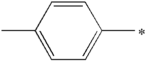 | Cl | —CH₂CH₂OSO₃H |
| 4 | C₂H₅ | 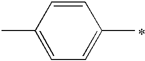 | Cl | —CH=CH₂ |
| 5 | C₂H₅ | ″ | F | —CH₂CH₂OSO₃H |
| 6 | C₂H₅ | 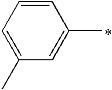 | F | —CH═CH₂ |
| 7 | H | ″ | F | —CH═CH₂ |
| 8 | H | ″ | Cl | —CH₂CH₂OSO₃H |
| 9 | H | 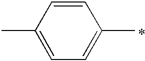 | Cl | —CH₂CH₂OSO₃H |
| 10 | H | 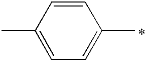 | Cl | —CH═CH₂ |
| 11 | H | ″ | F | —CH₂CH₂OSO₃H |
| 12 | H | ″ | F | —CH═CH₂ |
| 13 | H | 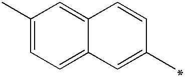 | F | —CH₂CH₂OSO₃H |
| 14 | H | 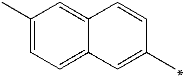 | Cl | —CH₂CH₂OSO₃H |
| 15 | H | 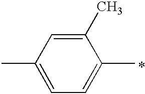 | Cl | —CH₂CH₂OSO₃H |
| 16 | H | 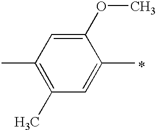 | Cl | —CH₂CH₂OSO₃H |
| 17 | H | 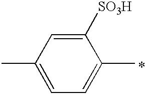 | Cl | —CH═CH₂ |
| 18 | H | ″ | F | —CH═CH₂ |
| 19 | H | —CH₂CH₂—* | Cl | —CH₂CH₂OSO₃H |
| 20 | H | —CH₂CH₂—* | F | —CH₂CH₂OSO₃H |
| 21 | H | —CH₂CH₂—O— | Cl | —CH₂CH₂OSO₃H |
| | | CH₂CH₂—* | | |
| 22 | CH₃ | —CH₂CH₂—O— | F | —CH₂CH₂OSO₃H |
| | | CH₂CH₂—* | | |
| 23 | H | 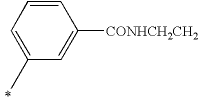 | F | —CH₂CH₂OSO₃H |
| 24 | H | ″ | Cl | —CH₂CH₂OSO₃H |

the * marks where the group B is attached to the nitrogen-atom.

### APPLICATION EXAMPLE A

0.3 of the dyestuff of Example 1 is dissolved in 100 parts of demineralized water and 6 parts Glauber's salt (calcined) is added. The dyebath is heated to 50° C., then 10 parts of cotton fabric (bleached) are added. After 30 minutes at 50° C., 0.4 part of sodium carbonate (calcined) is added to the bath. During the addition of sodium carbonate the temperature is kept at 50° C. Subsequently, the dyebath is heated to 60° C. and dyeing is effected for a further one hour at 60° C.

The dyed fabric is then rinsed with running cold water for 3 minutes and afterwards with running hot water for a further 3 minutes. The dyeing is washed at the boil for 15 minutes in 500 parts of demineralized water in the presence of 0.25 part of Marseille soaps. After being rinsed with running hot water (for 3 minutes) and centrifuged, the dyeing is dried in a cabinet drier at about 70° C. A yellow cotton dyeing is obtained.

### APPLICATION EXAMPLE B

To a dyebath containing in 100 parts of demineralized water and 8 parts Glaubers salt (calcined) 10 parts of cotton fabric (bleached) are added. The bath is heated to 50° C. within 10 minutes, and 0.5 part of the dyestuff of Example 1 is added. After a further 30 minutes at 50° C., 1 part of sodium carbonate (calcined) is added. The dyebath is then heated to 60° C. and dyeing is continued at 60° C. for a further 45 minutes.

The dyed fabric is rinsed with running cold and then hot water and washed at the boil according to the method of application Example A. After rinsing and drying a yellow cotton dyeing is obtained.

Similarly, the dyestuffs of Examples 2-24 or mixtures of the exemplified dyestuffs are employed to dye cotton in accordance with the method described in Application Example A or B.

### APPLICATION EXAMPLE C

A printing paste consisting of

| | |
|---|---|
| 40 | parts of the dyestuff of Example 1 |
| 100 | parts of urea |
| 350 | parts of water |
| 500 | parts of a 4% sodium alginate thickener and |
| 10 | parts of sodium bicarbonate |
| 1000 | parts in all |

is applied to cotton fabric in accordance with conventional printing methods.

The printed fabric is dried and fixed in steam at 102-104° C. for 4-8 minutes. It is rinsed in cold and then hot water, washed at the boil (according to the method described in Application Example A) and dried. A yellow print is obtained which has good general fastness properties.

Similarly, the dyestuffs of Examples 2 to 24 or mixtures of the exemplified dyestuffs are employed to print cotton in accordance with the method given in Application Example C.

### APPLICATION EXAMPLE D

2.5 parts of the dyestuff obtained in Example 1 are dissolved with stirring at 25° C. in a mixture of 20 parts diethyleneglycol and 77.5 parts water to obtain a printing ink suitable for ink jet printing.

The dyestuffs of Examples 2 to 24 or dyestuff mixtures of Examples 1 to 24 can also be used in a manner analogous to that described in Application Examples D.

1. A compound according to formula (I) 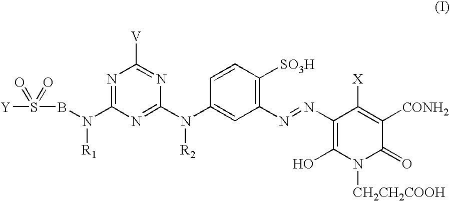
wherein
B is a divalent group,
R₁ and R₂ are independently from each other h or an optionally substituted C₁₋₆-alkyl group,
V is Cl or F,
X signifies a —C₁₋₆-alkyl group,
Y signifies a —CH═CH₂ group or a —CH₂CH₂-Z group, wherein Z is a radical which can be eliminated by alkali
or a salt thereof and/or mixtures thereof.

2. A compound of formula (I) according to claim 1 wherein B is an aliphatic, an aromatic or an araliphatic group.

3. A compound of formula (I) according to claim 1 or 2 wherein B can be substituted by one or more substituents and/or interrupted by one or more heteroatoms.

4. A compound of formula (I) according to anyone of the preceding claims or a salt thereof and/or a mixture thereof characterized in that X is a C₁₋₄-alkyl group.

5. A compound of formula (I) according to anyone of the preceding claims or a salt thereof and/or a mixture thereof characterized in that Z is a —OSO₃H-group.

6. A compound of formula (I) according to anyone of the preceding claims or a salt thereof and/or a mixture thereof characterized in that R₁ and R₂ are independently from each other H or an unsubstituted C₁₋₄-alkyl group.

7. A process of forming a fiber-reactive dyestuff of formula (I) as defined in anyone of the preceding claims or a salt thereof comprising the step of reacting a diazotized compound of the formula (II) 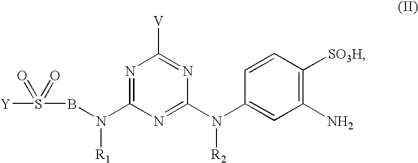
wherein B, V, R₁ and R₂ have the meanings as defined in any of the preceding claims
with a compound of the formula (III) 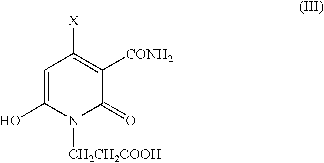
wherein X has the meaning as defined in any of the preceding claims.

8. Use of a fiber-reactive dyestuff of formula (I) or a mixture thereof as defined in any of the preceding claims 1 to 6 for dyeing or printing hydroxy-group-containing or nitrogen-containing organic substrates.

9. A process for the preparation of ink-jet inks comprising the use of a dyestuff or a mixture of dyestuffs according to any one of claims 1 to 6.

10. A hydroxy-group-containing or nitrogen-containing organic substrate dyed or printed with a fiber-reactive dyestuff of formula (I) as defined in any of claims 1 to 6.
